(19) United States
(12) Patent Application Publication
(10) Pub. No.: US 2014/0324655 A1
(43) Pub. Date: Oct. 30, 2014

(54) ELECTRONIC SYSTEM, COMPUTING DEVICE AND METHODS FOR UPDATING DATA RECORDS ACROSS MULTIPLE ELECTRONIC CREDIT DATABASES

(71) Applicant: CREDITCAST INC., Toronto (CA)

(72) Inventor: Nanda Kishore Kolathur, Toronto (CA)

(73) Assignee: CREDITCAST INC., Toronto (CA)

(21) Appl. No.: 13/871,430

(22) Filed: Apr. 26, 2013

(51) Int. Cl. G06Q 40/02

(52) U.S. Cl. CPC G06Q 40/025
USPC 705/37

(57) ABSTRACT

According to embodiments described in the specification, systems and methods are provided for reducing the divergence of credit report data across multiple credit databases. A computing device is configured to send an initial credit inquiry to a server maintaining a credit database. Based on a response from the server, the computing device is further configured to report data based on credit inquiry data to other servers maintaining other credit databases for updating the databases. The computing device can also be configured to report data based on credit inquiry data to subscribers other than the servers. Credit inquiry data can be reported to servers which did not receive an initial credit inquiry, and such servers are configured not to respond to the reporting with credit report data, but to update the databases.

### FIELD

The specification relates generally to data records in electronic credit databases, and specifically to an electronic system, computing device and methods for updating data records between multiple such electronic credit databases.

### BACKGROUND

Various lenders offer credit products to consumers. Lenders can request credit reports before extending credit to a given consumer. In general, before extending credit, each lender system is configured to request a credit report from a particular one of various credit reporting agencies maintaining credit databases. The contents of credit reports stored in the databases can be influenced by lender requests for credit reports. Thus, because certain lenders may only interact with certain credit databases, harmonization of the various databases is unreliable, and can result in the inefficient use of computational resources.

### BRIEF DESCRIPTIONS OF THE DRAWINGS

Embodiments are described with reference to the following figures, in which:

FIG. 1 depicts a prior art credit system;

FIG. 2 depicts a system for updating multiple credit databases, according to a non-limiting embodiment;

FIG. 3 depicts a method of updating credit data performed by the computing device of FIG. 2, according to a non-limiting embodiment;

FIG. 4 depicts a database maintained in the method of FIG. 3, according to a non-limiting embodiment;

FIG. 5 depicts credit request data received in the method of FIG. 3, according to a non-limiting embodiment;

FIG. 6 depicts the transmission of a first message in the method of FIG. 3, according to a non-limiting embodiment;

FIG. 7 depicts the transmission of a second message in the method of FIG. 3, according to a non-limiting embodiment;

FIG. 8 depicts a method of updating credit data performed by the servers of FIG. 2, according to a non-limiting embodiment;

FIG. 9 depicts a credit database maintained in the method of FIG. 8, according to a non-limiting embodiment;

FIG. 10 depicts an updated version of the database of FIG. 9, according to a non-limiting embodiment;

FIG. 11 depicts a database maintained in the method of FIG. 3, according to another non-limiting embodiment; and

FIG. 12 depicts a system for updating multiple credit databases, according to another non-limiting embodiment.

### DETAILED DESCRIPTION OF THE EMBODIMENTS

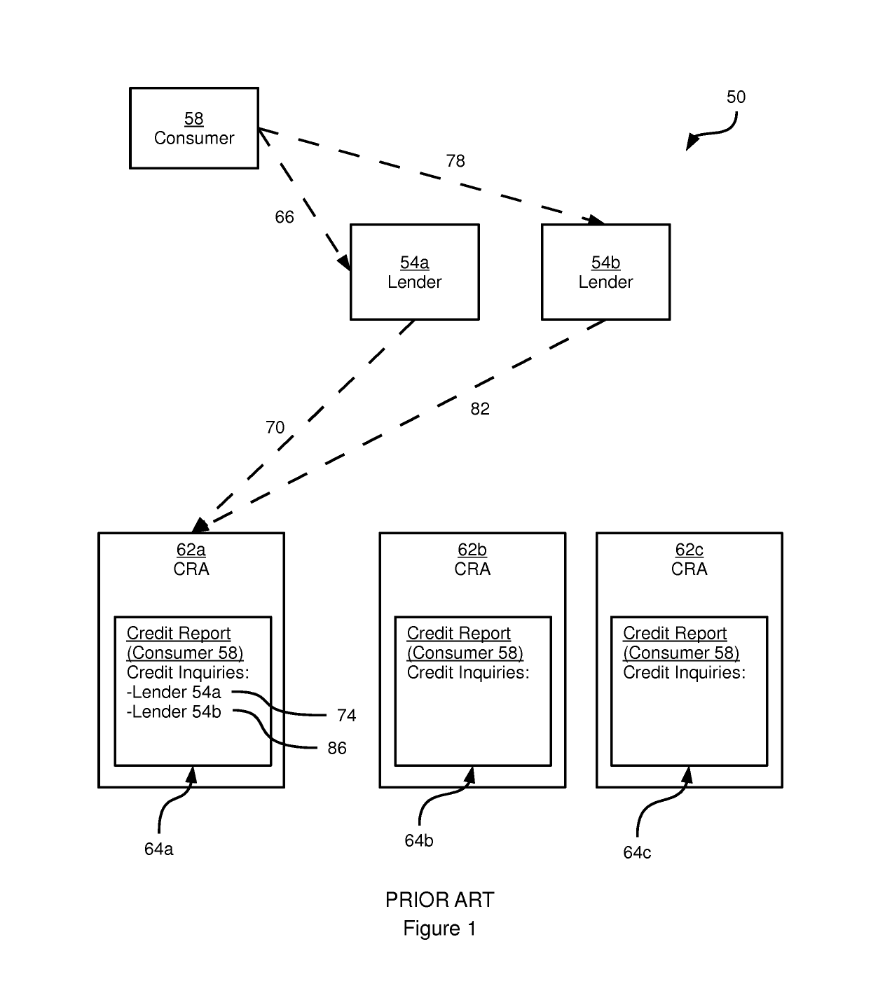

FIG. 1 depicts a prior art system 50 including two lenders 54a and 54b (generically referred to as a lender 54, and collectively referred to as lenders 54; this nomenclature is also used for other elements herein), which can be financial institutions such as banks. System 50 also includes a consumer 58, and three credit reporting agencies (CRAs), also referred to as credit bureaus, 62a, 62b and 62c. System 50 can include any number of lenders 54, consumers 58 and CRAs 62.

CRAs 62 store credit report data 64a, 64b and 64c for consumer 58, as well as for other consumers (only a portion of the credit report data for consumer 58 is shown in FIG. 1 for simplicity of illustration; additional credit report data can be stored for consumer 58, such as identity information, credit account payment history, public records and the like; credit report data can also be stored for other consumers). Such credit report data includes various parameters that are used by CRAs 62 to generate a credit report for consumer 58. Among the parameters are credit inquiry parameters, which provide indications of how many times consumer 58 has requested new credit products, which typically results from a lender 54 accessing credit report data of consumer 58 at a CRA 62 in order to make a decision on approval of the new credit products.

Credit inquiries are one of the factors that determine the performance of various services built on or derived from the credit report of consumer 58, such as credit and identity monitoring services, account monitoring services, credit risk models, marketing models, fraud models and the like. For example, a service monitoring requests for new credit products (that is, new credit inquiries) can provide a defense against identity theft by allowing consumer 58 to be alerted of potentially fraudulent activity (suggested by credit inquiries in the name of consumer 58, when such new credit inquiries were not authorized by consumer 58). Credit inquiries are also one of the factors that determine the credit risk of consumer 58. For example, a higher number of new credit product requests made by consumer 58 causing new credit inquiries can negatively affect the credit risk of consumer 58, resulting in a credit report for consumer 58 that indicates a lower credit score.

Lenders 54 receive requests for credit products (e.g. credit cards, mortgages and the like) from consumer 58 and other consumers, and approve or deny those requests based at least in part on information that lenders 54 receive from CRAs 62.

More specifically, when consumer 58 makes a request for a credit product to lender 54a (shown as a request 66 in FIG. 1), lender 54a in turn requests a credit report for consumer 58 from CRA 62a (shown as a request 70 in FIG. 1). Request 70 is referred to as a “hard credit inquiry” or a “hard inquiry”, as request 70 indicates that consumer 58 has requested a credit product which lender 54a was not already providing to consumer 58. This may be because consumer 58 is a new customer of lender 54a, or because consumer 58 is an existing customer of lender 54a but was not being provided with the particular product identified by request 66. Hard credit inquiries, as will now be apparent to those skilled in the art, are contrasted with “soft credit inquiries” or “soft inquiries”, which are typically not associated with requests for new credit products. Soft credit inquiries are typically associated with requests for credit reports that are not related to applications for new credit products by consumers. Examples of such requests are ongoing monitoring of the credit report of an existing customer by lenders 54 or by providers of the monitoring services mentioned above to which consumer 58 has subscribed. Thus, although soft credit inquiries can be tracked by CRAs 62 separately from hard credit inquiries, soft inquiries do not adversely affect the credit risk of consumer 58.

Having received request 70, CRA 62a retrieves the credit report data associated with consumer 58 and returns that data to lender 54a. CRA 62a also updates the credit report data to include an indication that a hard credit inquiry has been made in connection with consumer 58 by lender 54a. As shown in FIG. 1, an indication 74 that a hard inquiry was made by lender 54a in connection with consumer 58 is stored at CRA 62a. Any future requests to CRA 62a for the credit report data of consumer 58 can reveal that request 70 was made by lender 54a.

CRAs 62b and 62c, however, do not contain any indications that a hard inquiry has been made in connection with consumer 58. To further illustrate this point, assume that after request 66, consumer 58 makes a second request 78 to lender 54b for a new credit product (meaning a credit product that lender 54b was not already providing to consumer 58). As discussed above, in response to request 78, lender 54b sends a request for credit report data to one of CRAs 62. Assuming that lender 54b is configured to send hard inquiries to CRA 62a, lender 54b sends a request 82 to CRA 62a, and CRA 62a responds by returning the credit report data for consumer 58 (now including indication 74) and by updating that credit report data to include an additional indication 86. Thus, the credit report data maintained by CRA 62a contains indications that two hard credit inquiries have been made in connection with consumer 58. CRAs 62b and 62c, meanwhile, contain no such indications.

It will now be apparent from the above discussion that the performance of certain services, such as identity theft monitoring services, can vary (and can be negatively affected) depending on which CRA 62 is consulted by such services. For example, a monitoring service that retrieves credit report data only from CRA 62b remains unaware of the hard credit inquiries described above, and therefore may not generate any alerts for consumer 58. To address such information gaps, in some existing systems, services such as the above-mentioned identity theft monitoring services retrieve credit report data from multiple CRAs to build composite credit reports, to monitor the composite credit reports for new hard inquiries, and to generate alerts based on such new hard inquiries. The additional activity required to monitor multiple CRAs and build composite credit reports can result in delayed alert generation, and consumes greater computational resources.

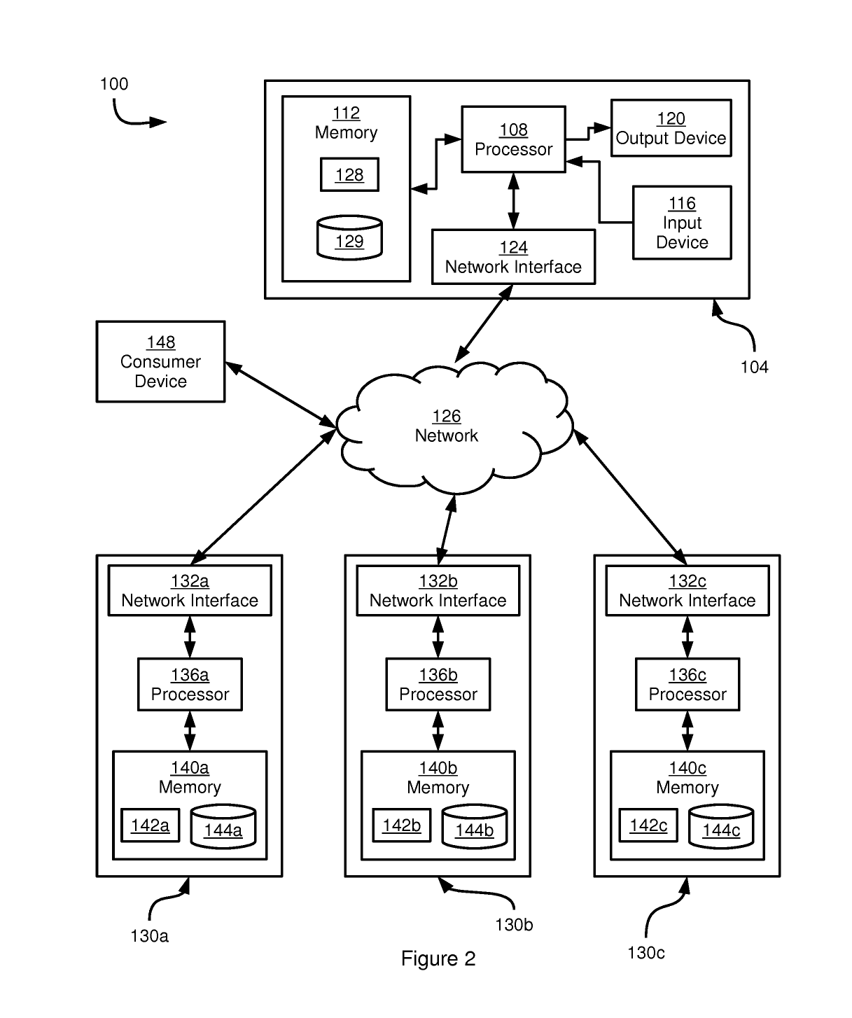

Turning now to FIG. 2, a system 100 is depicted for updating multiple credit databases. System 100 includes a computing device 104, which in the present example is based on the computing environment and functionality of a desktop computer. Computing device 104 is not limited, however, to a desktop computer. Other devices are also contemplated, including laptop computers, smart phones, tablet computers and the like.

Computing device 104 includes a processor 108 interconnected with a computer readable storage medium such as a memory 112. Memory 112 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In the present example, memory 112 includes both a volatile memory and a non-volatile memory. Other types of non-transitory computer readable storage medium are also contemplated, such as compact discs (CD-ROM, CD-RW) and digital video discs (DVD).

Computing device 104 also includes one or more input devices interconnected with processor 108, illustrated generically as an input device 116. Such input devices can include any one of, or any suitable combination of, a keypad, a keyboard, a mouse, a microphone, a touch screen, other sensors (e.g. light or temperature sensors) and the like. Input device 116 receives input, for example in the form of key presses on a keyboard, and transmits input data to processor 108 (continuing with the above example, such input data could be indicative of which keys were pressed).

Computing device 104 further includes one or more output devices interconnected with processor 108, illustrated generically as an output device 120. Output device 120 can include any one of, or any combination of, a display (e.g. a Liquid Crystal Display (LCD), a plasma display, an Organic Light Emitting Diode (OLED) display, a Cathode Ray Tube (CRT) display, and the like), one or more speakers, and the like. It is contemplated that when input device 116 includes a touch screen and output device 120 includes a display, the touch screen and the display can be integrated with each other.

Computing device 104 also includes a network interface 124 interconnected with processor 108. Network interface 124 allows computing device 104 to communicate with other computing devices via a link with a network 126, or via a direct, local connection (such as a Universal Serial Bus (USB) or Bluetooth™ connection, not shown). Network 126 can include any suitable combination of wired and/or wireless networks, including but not limited to a Wide Area Network (WAN) such as the Internet, a Local Area Network (LAN), cell phone networks, WiFi networks, WiMax networks and the like.

Network interface 124 is therefore selected for compatibility with network 126, as well as with local links as desired. In the present example, the link between interface 124 and network 126 is a wired link, such as an Ethernet link. Network interface 124 thus includes the necessary hardware for communicating over such a link. In other examples, the link between computing device 104 and network 126 can be wireless, and network interface 124 can include (in addition to, or instead of, any wired-link hardware) one or more transmitter/receiver assemblies, or radios, and associated circuitry. For example, network interface 124 can include a first assembly, or radio, for enabling communications over a WiFi network, and a second radio for enabling communications over one or more mobile telephone networks (e.g. 3G networks).

Computing device 104 stores, in memory 112, a plurality of computer readable instructions executable by processor 108. These instructions include an operating system and a variety of applications. Among the applications in memory 112, as illustrated in FIG. 2, is a credit request application 128 (also referred to herein as “application 128”). When processor 108 executes the instructions of application 128, processor 108 is configured to perform various functions specified by the computer readable instructions of application 128, as discussed below in greater detail. Computing device 104 can be operated by a lender, such as one of lenders 54a and 54b discussed above. Computing device 104 also stores in memory 112 a subscriber database 129, which is discussed below in greater detail.

System 100 also includes a plurality of servers 130a, 130b and 130c. Servers 130 each include network interfaces, processors and memories that are as described above in connection with computing device 104. Thus, servers 130a, 130b and 130c include network interfaces 132a, 132b and 132c, respectively, allowing servers 130 to communicate with other devices via network 126. Servers 130a, 130b and 130c also include processors 136a, 136b and 136c, respectively, for executing computer readable instructions stored in memories 140a, 140b and 140c, respectively.

The computer readable instructions stored in memories 140 include credit reporting applications 142a, 142b and 142c. In addition, memories 140 store credit databases 144a, 144b and 144c. Processors 136 of servers 130 are configured, via execution of applications 142, to perform various functions as described in detail below. Servers 130a, 130b and 130c can be operated by CRAB, such as CRAB 64a, 64b and 64c respectively, discussed above in connection with FIG. 1. It is contemplated, however, that in other examples servers 130 can be operated by other entities.

System 100 further includes a consumer device 148. Device 148 can be any of a desktop computer, smart phone, laptop computer, tablet computer, and the like. Device 148 thus includes a processor, a memory, input and output devices, and a network interface as described above in connection with computing device 104. Device 148 can be operated by a consumer, such as consumer 58 discussed above in connection with FIG. 1.

It is contemplated that system 100 can include additional computing devices 104 (not shown) operated by additional lenders. System 100 can also include fewer servers 130 than shown, or additional servers 130 operated by additional CRAs (or, as mentioned above, other suitable entities), and can also include additional devices 148 operated by additional customers.

Briefly, computing device 104 is configured, via the execution of application 128, to receive credit request data and generate a first message addressed to one of servers 130 based on such credit request data. Computing device 104 is also configured, depending on the nature of the response to the first message received, to send additional messages to one or more of servers 130, or to consumer device 148, or to consumer device 148 and one or more of servers 130. Servers 130 are configured, via the execution of respective applications 142, to receive the above-mentioned messages from computing device 104, and depending on the content of those messages, either to respond and update databases 144, or to only update databases 144.

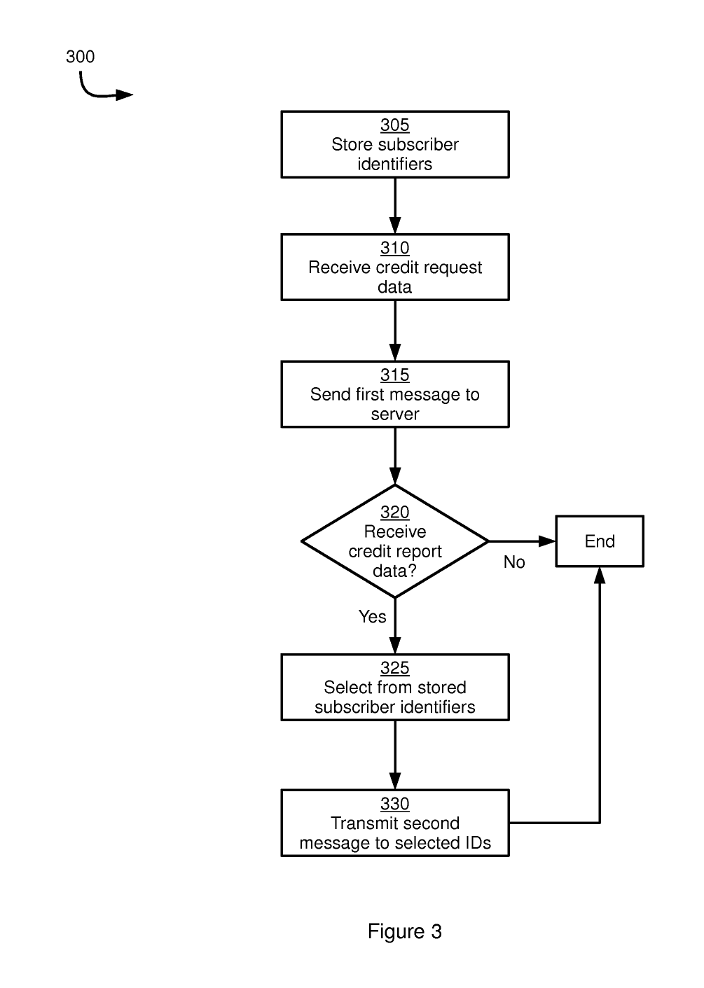

Referring now to FIG. 3, a flowchart is shown, depicting a method 300 for updating credit report data across multiple credit databases. Method 300 is performed by computing device 104. More particularly, the blocks of method 300, to be discussed below, are performed by processor 108, in conjunction with the other components of computing device 104, as configured via the execution of application 128 by processor 108.

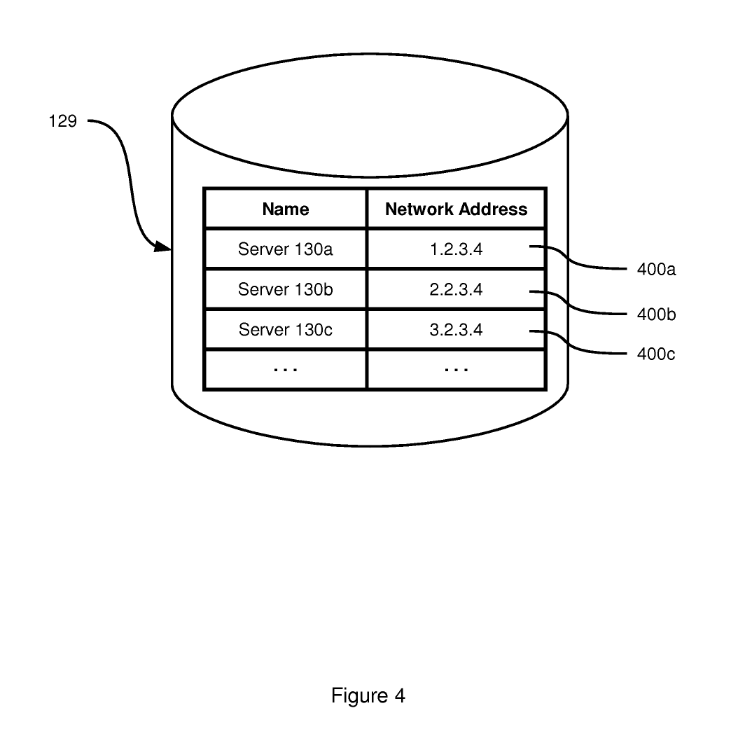

Beginning at block 305, computing device 104 is configured to store subscriber identifiers in memory 112. Each subscriber identifier corresponds to a subscriber device, such as a server 130 or consumer device 148. Subscriber identifiers are stored in database 129. Turning to FIG. 4, an example database 129 is shown, including three subscriber identifiers 400a, 400b and 400c (one for each of servers 130). In the present example, identifiers 400 are network addresses, such as Internet Protocol (IP) addresses. In other examples, however, other suitable identifiers can be used, such as domain names, Media Access Control (MAC) addresses, Mobile Subscriber ISDN Numbers (MSISDNs), and the like. Database 129 can also include a name in association with each identifier 400; the names are provided for illustrative purposes, and can be omitted from database 129.

As discussed in greater detail below, the subscriber identifiers stored in database 129 identify computing devices to which specific messages are sent by computing device 104 during the performance of method 300.

Returning to FIG. 3, the performance of method 300 continues at block 310. At block 310, computing device 104 is configured to receive, and store in memory 112, credit request data. In general, the credit request data details a request for a credit product by a requesting party. In the present example performance of method 300, it is assumed that the requesting party, or requester, is the operator (also referred to herein as “the consumer”) of consumer device 148, such as consumer 58. The requester can be a person, business, institution or the like, and in the present example the request is assumed to be a request from consumer 58 for a line of credit offered by the lender operating computing device 104.

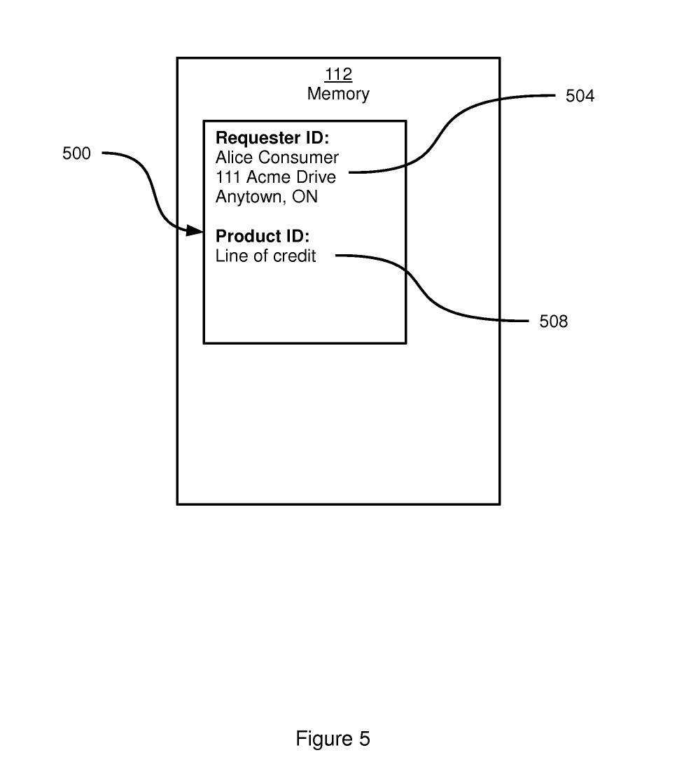

The credit request data received at block 310 can include a requester identifier, and can also include an identifier of the credit product that the requester is applying for. Turning to FIG. 5, an example is shown of the credit request data stored in memory 112 following its receipt at block 310. In particular, credit request data 500 is shown, including a requester identifier 504 and a product identifier 508. The nature of identifiers 504 and 508 is not particularly limited, but serves to uniquely identify the requester and the credit product being requested, respectively. In the present example, requester identifier 504 includes a name (“Alice Consumer”) and an address (“111 Acme Drive, Anytown, Ontario”). In other examples, requester identifier 504 could include, instead of or in addition to the name and address shown, a number (such as a social insurance number, a business number, a customer number assigned automatically by computing device 104, and the like). Credit request data 500 can also include other data (not shown), such as indications of requester income or assets, and the like.

The manner in which credit request data 500 is received at computing device 104 is not particularly limited. In the present example performance of method 300, credit request data 500 is received at processor 108 from input device 116, for example following an in-person meeting between the consumer and a representative of the lender operating computing device 104. In other examples, however, credit request data 500 can be received at network interface 124 via network 126, having been sent by consumer device 148 (for instance, a credit request web page form can be hosted by computing device 104 and available to consumer device 148 over network 126).

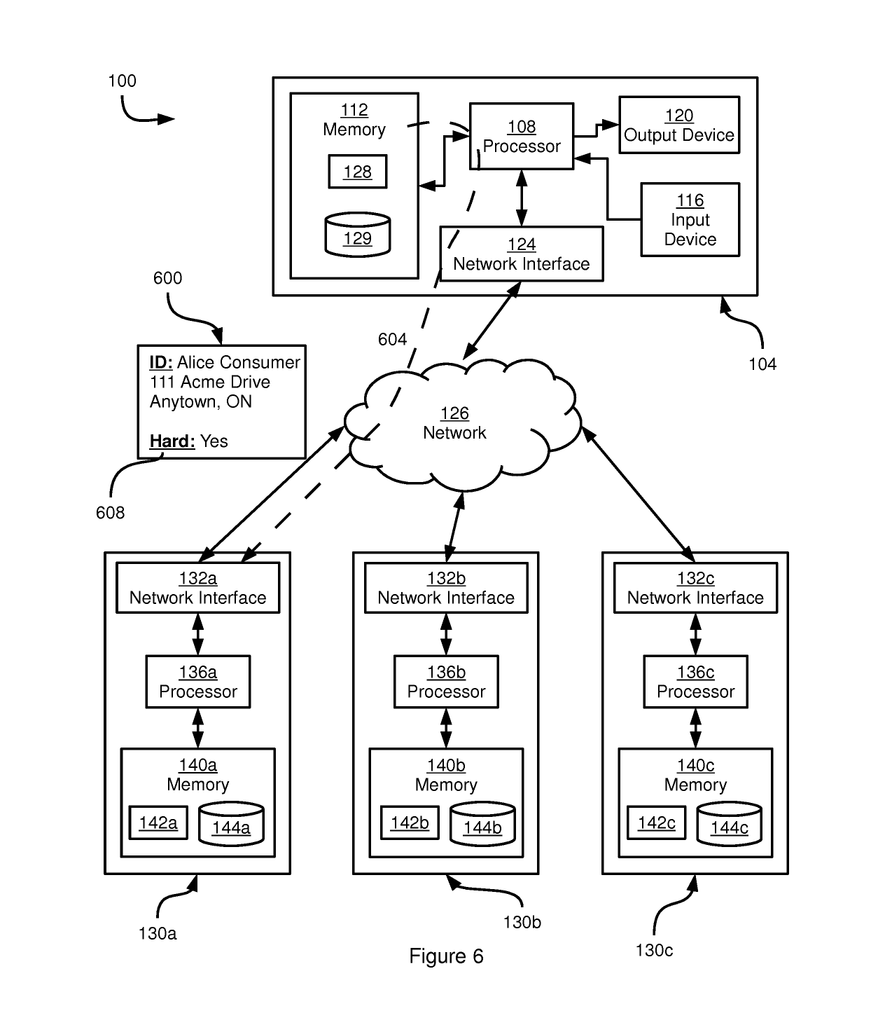

Referring again to FIG. 3, in response to receiving credit request data 500, at block 315 computing device 104 is configured to transmit a first message, including a portion of the credit request data, from network interface 124 to a server maintaining a credit database. Processor 108 is therefore configured, via execution of application 128, to generate the first message based on credit request data 500 and to transmit the first message. FIG. 6 shows an example of the performance of block 315 in system 100. Consumer device 148 is not shown in FIG. 6, to improve visibility of the remaining elements.

As seen in FIG. 6, at block 315 processor 108 is configured to retrieve credit request data 500 from memory 112, generate a first message 600 using credit request data 500, and transmit first message 600 to a first server 130, in particular server 130a in this example, via network 126 (along the path 604 shown as a dashed line). First message 600 includes at least a portion of credit request data 500. In the present example, first message 600 includes requester identifier 504 to allow server 130a to locate the correct record in database 144a, as discussed in greater detail below. In addition, first message 600 includes a flag 608 indicating whether or not first message 600 represents a hard credit inquiry, as discussed above (that is, a credit inquiry based on an application for a new credit product which can be used to update credit report data in database 144a). The nature of flag 608 is not particularly limited. For example, the value “Yes” shown in FIG. 6 can be replaced with a bit flag or other alphanumerical value. Flag 608 can have one of two values, or can indicate that it is or is not a hard inquiry by the presence or absence of a single value. It is also contemplated that first message 600 includes other data necessary to ensure its delivery, such as a network address for server 130a (not shown). A positive hard inquiry indication such as that shown in FIG. 6 is an instruction to the recipient server 130 to respond to first message 600 with credit report data associated with consumer 58, and to update credit database 144.

At block 315, computing device 104 need not transmit first message 600 to server 130a. It is contemplated that first message 600 can be transmitted to any one of servers 130, or to another CRA-operated server not shown in FIG. 2 or 6 (although as mentioned earlier, such other servers need not be operated by CRAs). The particular server 130 to which first message 600 is addressed can be identified in memory 112 of computing device 104. In general, computing device 104 is configured to send first message 600 to only one server 130 (and more generally, to send all hard credit inquiries to that same server 130). In the present example performance of method 300, computing device 104 is configured to send first message 600 to server 130a.

Upon receipt of first message 600, server 130a is configured to retrieve credit report data corresponding to the requester identifier in first message 600, if such data is available, and return such data to computing device 104. If no such data is available (for example, if database 144a contains no records corresponding to the requester identifier in first message 600), server 130a is configured to return an error message (i.e. a message to indicate that no credit record related to the requester identifier exists in database 144a) to computing device 104. It is contemplated that servers 130b and 130c are configured to respond similarly to any messages they receive having the same format as first message 600.

Returning to FIG. 3, the performance of method 300 continues at block 320, at which computing device 104 is configured to determine whether credit report data was received in response to first message 600. The determination at block 320 can be performed by determining whether the response from server 130a includes credit report data corresponding to the consumer “Alice Consumer”, or an error message. If the response includes credit report data, the determination at block 320 is affirmative. If the response includes an error message, however, the determination at block 320 is negative, and the performance of method 300 ends. In some examples, following a negative determination at block 320, instead of ending, the performance of method 300 can return to block 315 at which computing device can send first message 600 to a different server 130. Thus, computing device 104 can be configured to attempt to retrieve credit report data from different servers 130 until an attempt is successful, or until all attempts have failed (i.e. none of databases 144 contain a credit record related to the requester identifier from first message 600).

For the present example performance of method 300, it is assumed that the response received from server 130a includes credit report data corresponding to the requester identifier in first message 600. Therefore, the determination at block 320 is affirmative, and computing device 104 is configured to proceed to block 325.

At block 325, computing device 104 is configured to select one or more subscriber identifiers from database 129. Various factors may be considered by computing device 104 in selecting identifiers from database 129, as discussed in detail later herein. In the present example performance of method 300, computing device 104 is configured to select all the subscriber identifiers in database 129 with the exception of the identifier of server 130a, to which first message 600 was sent. In other words, when database 129 contains a subscriber identifier corresponding to the server to which first message 600 was sent at block 315, that subscriber identifier is excluded from the selection at block 325. When database 129 contains a subscriber identifier corresponding to consumer device 148, computing device 104 only selects that subscriber identifier when the requester identifier 504 is also associated with consumer device 148.

In the present example, computing device 104 is therefore configured to select the network addresses for servers 130b and 130c (but not 130a) shown in FIG. 4. Having selected the subscriber identifiers, computing device is then configured to perform block 330 of method 300.

At block 330, computing device 104 is configured to generate a second message, and transmit the second message to each subscriber identifier selected at block 325. The second message sent at block 330 includes data based on a portion (up to and including the entirety) of the credit request data received at block 310, and an indicator for causing the recipient subscriber devices not to respond to the second message with credit report data. The second message can therefore include the requester identifier, and can also include an identifier of the originator, or sender, of first message 600. Thus, in the present example, the requester identifier identifies consumer 58, and the sender identifier identifies computing device 104 (operated by lender 54a). In other examples, the second message can also include an identifier of the first server (server 130a, to which first message 600 was sent), a date and time when first message 600 was sent, and the like. It is contemplated that the second message can also be based in part on other data not mentioned above, and therefore can be said to be based at least in part on the credit request data received at block 310. Further references herein to data being generated, stored, sent and the like “based on” certain data are inclusive of such data being generated both on that certain data and on other factors.

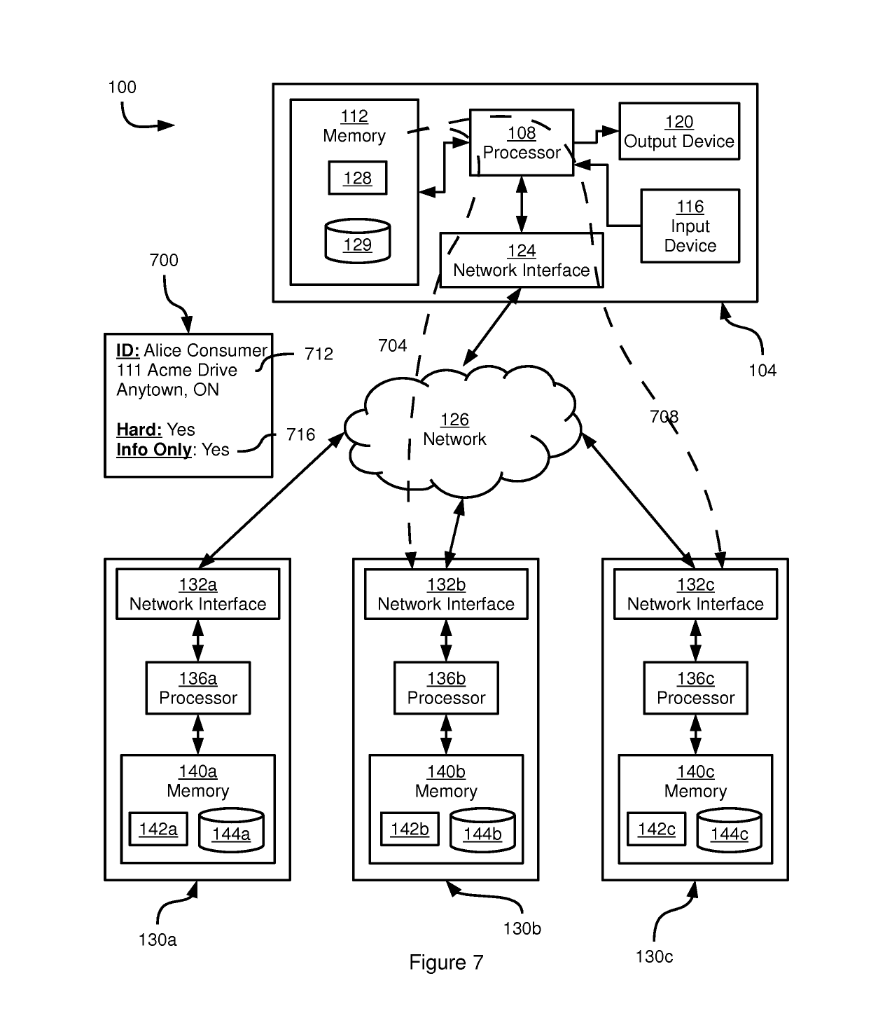

Turning to FIG. 7, an example of the performance of block 330 is shown. Specifically, a second message 700 is sent, via paths 704 and 708, from computing device 104 to each of servers 130b and 130c. Second message 700 includes a requester identifier 712 derived from the requester identifier in data 500 (in the present example, identifier 712 is identical to identifier 504, although this is not a necessity). Second message 700 also includes an indicator 716 in the form of an “information only” flag. Indicator 716 is an instruction to the recipient subscriber devices to not respond to second message 700 with credit report data. It is contemplated that although recipient subscriber devices, such as servers 130, can respond with an acknowledgement that second message 700 was safely received, indicator 716 causes servers 130 to not respond with credit report data as they would following a hard credit inquiry such as first message 600.

As also seen in FIG. 7, second message 700 further includes a flag indicating that second message 700 represents a hard inquiry. Both the hard inquiry flag and indicator 716 need not appear as “yes” or “no” values as shown in FIG. 7. A wide variety of values, fields, flags and the like can be included in second message 700 in place of “yes” or “no” values. It is contemplated that in other examples, either or both of the hard inquiry flag and indicator 716 can be omitted, and computing device 104 can mark second message 700 as an “information only” message by sending second message 700 to specific network addresses of servers 130, or using a specific protocol, file format or the like which servers 130 are configured to recognize as being used for information only messages.

In the present example, as will become apparent in the discussion below, second message 700 is received at servers 130b and 130c, and used to update databases 144b and 144c to reflect the hard credit inquiry made by computing device 104 on behalf of consumer 58. However, servers 130b and 130c are configured to detect indicator 716 and, in response, to only update databases 144b and 144c, without responding to computing device 104 with credit report data similar to that mentioned above in connection with block 320. In other words, indicator 716 distinguishes second message 700 from a “regular” hard credit inquiry such as first message 600.

Following block 330, the performance of method 300 ends.

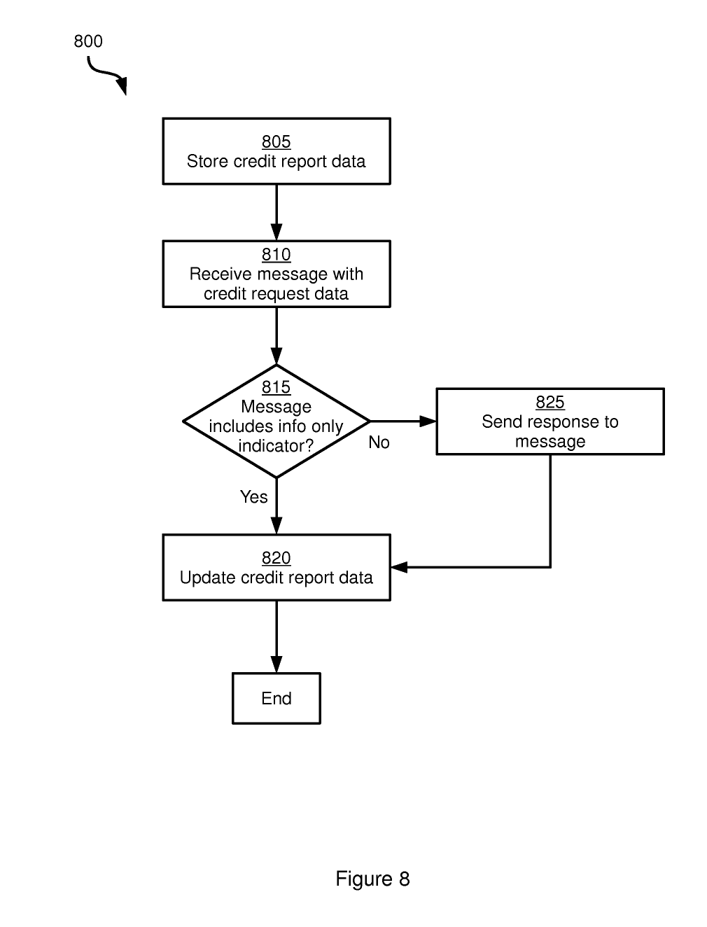

Referring now to FIG. 8, a flowchart is shown depicting a method 800 of updating a credit database. Method 800 is performed by each of servers 130. More particularly, the blocks of method 800, to be discussed below, are performed by processors 136, in conjunction with the other components of servers 130, as configured via the execution of applications 142 by processors 136. The performance of method 800 is discussed in conjunction with its performance by server 130b, alongside the performance of method 300 by computing device 104.

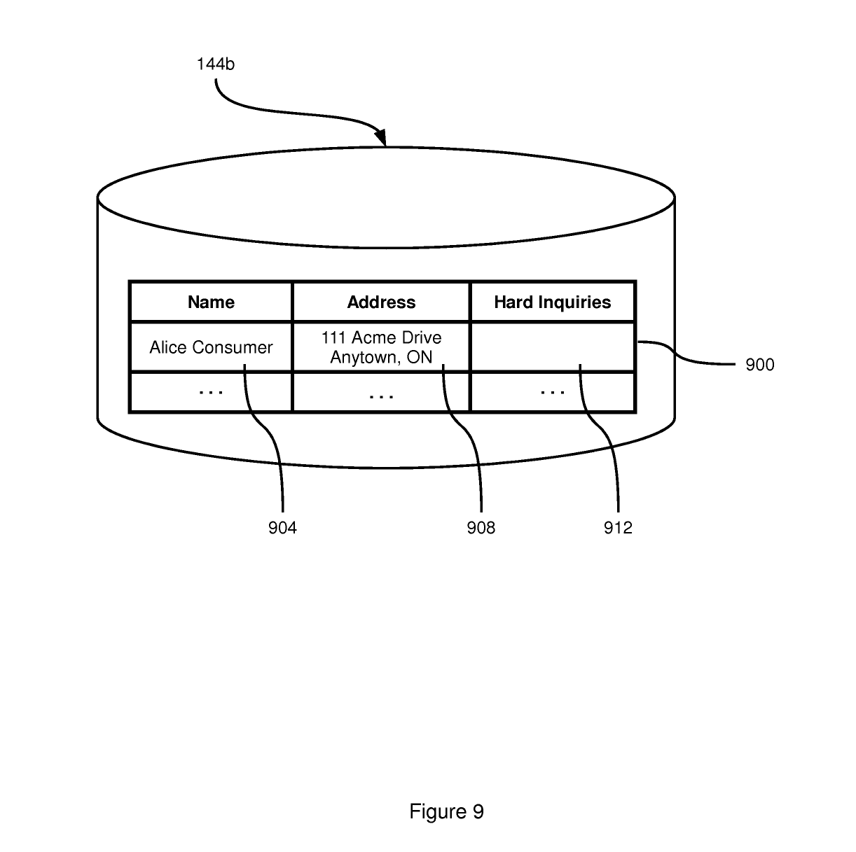

Beginning at block 805, server 130b is configured to store credit report data. As mentioned above, credit report data is stored in database 144b. More specifically, database 144b includes a plurality of records containing credit report data corresponding to various consumers. An example of database 144b is shown in FIG. 9, including one record 900 corresponding to the consumer named “Alice Consumer”. Record 900 includes a name field 904, an address field 908, and a hard inquiries field 912. Name field 904 and address field 908 include, respectively, the name and address for the consumer to whom record 900 corresponds. Field 912 includes indications of the hard credit inquiries that server 130b has received in connection with the consumer to whom record 900 corresponds. As can be seen in FIG. 9, field 912 is currently empty. This indicates that according to record 900, no hard credit inquiries have been made on behalf of consumer 58.

It is contemplated that database 144b can contain a wide variety of additional data in connection with record 900 (and any other records stored therein), but such data is not shown in FIG. 9 for the sake of simplicity. As mentioned earlier, such additional data can include identity information, credit account payment history, public records, and the like.

Returning to FIG. 8, at block 810 server 144b is configured to receive a message including a credit requester identifier. That is, the message received at block 810 includes some form of identification of a requesting party. In the present example, the message received at block 810 is second message 700 described above, and the requester identifier thus includes the name and address of Alice Consumer. As mentioned earlier, however, a variety of identifiers can be used in any of the messages described herein. Although the name and address from credit request data 500 have been used in the above examples, other identifiers derived from credit request data 500 can also be used, so long as such other identifiers allow the consumer to be uniquely identified by computing device 104 and server 130b.

Having received second message 700, at block 815 server 130b is configured to determine whether the received message includes an indicator instructing server 130b not to respond. That is, server 130b is configured to detect the presence or absence of a field or value such as indicator 716 in the received message. As discussed above, and as seen in FIG. 7, message 700 includes indicator 716, and therefore the determination at block 815 is affirmative. The performance of method 800 thus proceeds to block 820.

It is contemplated that in some examples, the performance of block 815 can include a determination as to whether the received message includes both an instruction not to respond and a hard inquiry indicator (which is an instruction to update database 144b). The determination is affirmative only when both the above-mentioned instructions are present. For ease of explanation, however, it is assumed that in the present example performance, all messages received at block 810 are hard credit inquiries (that is, method 800 is only invoked for hard credit inquiries).

At block 820, server 130b is configured to update the credit report data corresponding to the requester identifier contained in the message received at block 810. Thus, in the present example performance of method 800, server 130b is configured to update record 900. The update performed at block 820 includes updating hard inquiries field 912 with data corresponding to the message received at block 810. The nature of the update to field 912 is not particularly limited. For example, field 912 can contain a count of instructions received (in messages such as message 600 and message 700) to update database 144b—that is, a count of hard credit inquiries received—and server 130b can update field 912 by incrementing the count by one.

In the present example, field 912 contains, for each hard credit inquiry received at server 130b, an identifier of the originator of the message. At block 820, processor 136b is therefore configured to add an identifier of the originator of message 700 (that is, computing device 104) to field 912.

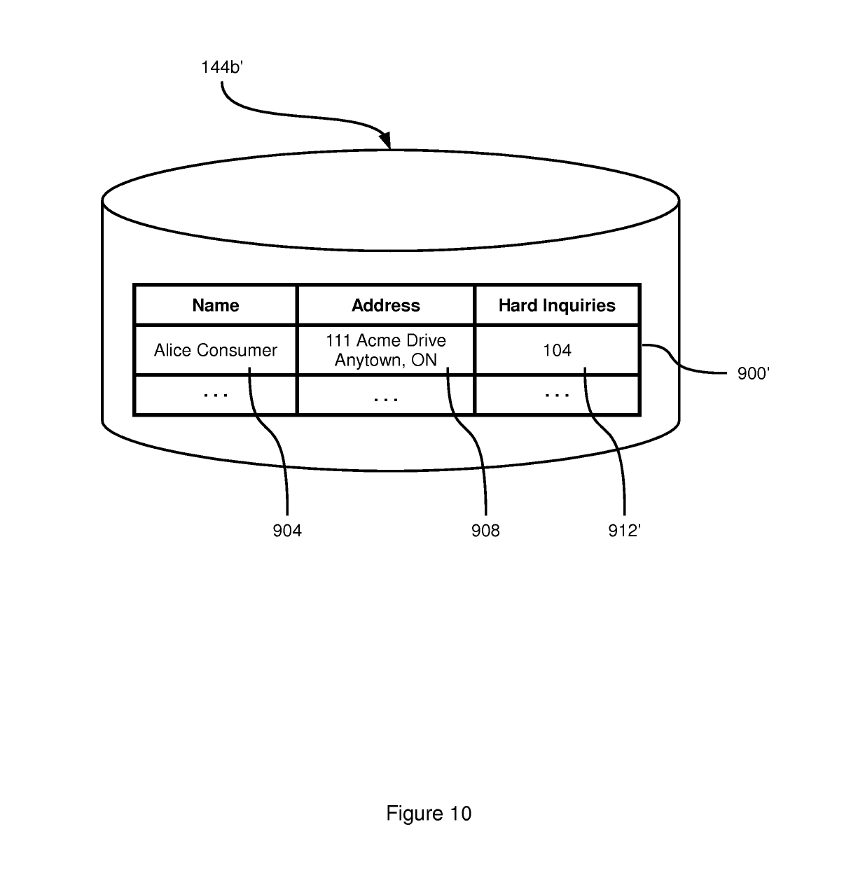

Referring to FIG. 10, the result of the performance of block 820 is shown. The update results in a database 144b′, in which field 912′ of record 900′ is an updated version of field 912. Field 912′ includes an identifier “104”, corresponding to computing device 104. The nature of the identifier stored in field 912 is not particularly limited—a network address, the name of an institution (e.g. the name of the lender operating computing device 104), and the like can be used as identifiers. When second message 700 includes other data, such as the date and time when first message 600 was sent, an identifier of the destination of first message 600 (server 130a in the present example), and the like, field 912′ can also store such other data.

Returning to FIG. 8, following the update to the credit report data in database 144b, the performance of method 800 ends.

Another example performance of method 800 will now be discussed, in conjunction with its performance by server 130a, still alongside the above example performance of method 300. It is assumed that the contents of database 144a are initially as shown in FIG. 9. As noted earlier, the message received at server 130a is not second message 700, but rather first message 600. Thus, at block 815, the determination is negative, because the message received at block 810 does not include an instruction not to respond. The determination at block 815 therefore allows servers 130 to distinguish between “true” hard credit inquiries (such as message 600) which require responses, and informational messages (such as message 700) which do not require responses

Following the negative determination at block 815, server 130a is configured to advance to block 825. At block 825, server 130a is configured to retrieve credit report data from database 144a and send the credit report data to the originator of the message received at block 810 (in this case, computing device 104). Alternatively, if no credit report data corresponding to the requester identified in message 600 exists in database 144a, the response sent at block 825 includes an error message. It will now be apparent to those skilled in the art that the response sent by server 130a at block 825 would be used in the determination by computing device 104 at block 320 described above.

Following block 825, the performance of method 800 by server 130a then proceeds to block 820, as described above (that is, the same update is performed as was performed by server 130b, but the update following a negative determination at block 815 is accompanied by a response from server 130a). After the performance of method 800 by server 130a, the contents of database 144a is as shown in FIG. 10.

It will now be apparent to those skilled in the art that a further performance of method 800 by server 130c, alongside the example performance of method 300 described above, is as described in connection with the performance of method 800 by server 130b. That is, server 130c, upon receipt of second message 700, updates database 144c as shown in FIG. 10 without responding to computing device 104.

Therefore, following the performance of method 300 by computing device 104, and the performance of method 800 by each of servers 130a, 130b and 130c, all three databases 144 are updated to reflect the hard credit inquiry represented by message 600, while only one response is received at computing device 104.

Certain advantages to the above system and methods will now be apparent to those skilled in the art. For example, since computing device 104 not only requests credit report data from server 130a, but also informs servers 130b and 130c of the request sent to server 130a (by way of second message 700), the databases 144 at all three servers 130 are updated to reflect the hard credit inquiry. In other words, the divergence of credit report data across multiple credit databases 144 is reduced and the accuracy of the credit report data maintained by servers 130 with respect to hard credit inquiries may be enhanced. Further, the exclusion of the server to which the “true” hard inquiry (first message 600) is sent when sending second message 700 avoids any double counting of hard inquiries at that server.

Credit report data can be used for a variety of services, including credit and identity monitoring services, account monitoring services, enhanced identity verification services, credit risk models, marketing models, and the like. The performance of these services can therefore also be enhanced by the above methods and systems. For example, as mentioned above, in the prior art scenario, CRAs 62b and 62c are not informed of some hard credit inquiries, and thus an identity monitoring service relying on CRAs 62b and 62c (but not CRA 62a) may not generate alerts for consumer 58 when such alerts can be generated (in response to new hard inquiries). The use of first and second messages 600 and 700 in the methods described above can reduce the likelihood that servers 130a, 130b and 130c will contain diverging records.

An additional example advantage to the above systems and methods is that the demands placed on computational and bandwidth resources in order to achieve the reduced divergence between databases mentioned above are relatively limited: message 700 need not contain a large volume of data, and no responses containing credit report data are required to message 700. That is, dependence on costly synchronization procedures performed on data obtained from CRAs 62 can be reduced.

An additional advantage is that due to the reduced divergence of the credit report data at servers 130, computing devices operated by lenders and other service providers (such as providers of identity monitoring services) can reduce or eliminate the need to monitor credit report data from multiple CRAs, thus further reducing bandwidth, processing and storage requirements. For instance, the need for the above-mentioned composite credit reports built from credit report data retrieved from multiple CRAs and used to monitor for new hard credit inquiries and generate alerts can be reduced by the systems and methods described herein. Since the credit report data at each server 130 can be rendered more complete than in the prior art, computationally costly systems which build composite credit reports from multiple CRAs and monitor for new hard credit inquiries can be relied upon less heavily. Other advantages will now occur to those skilled in the art.

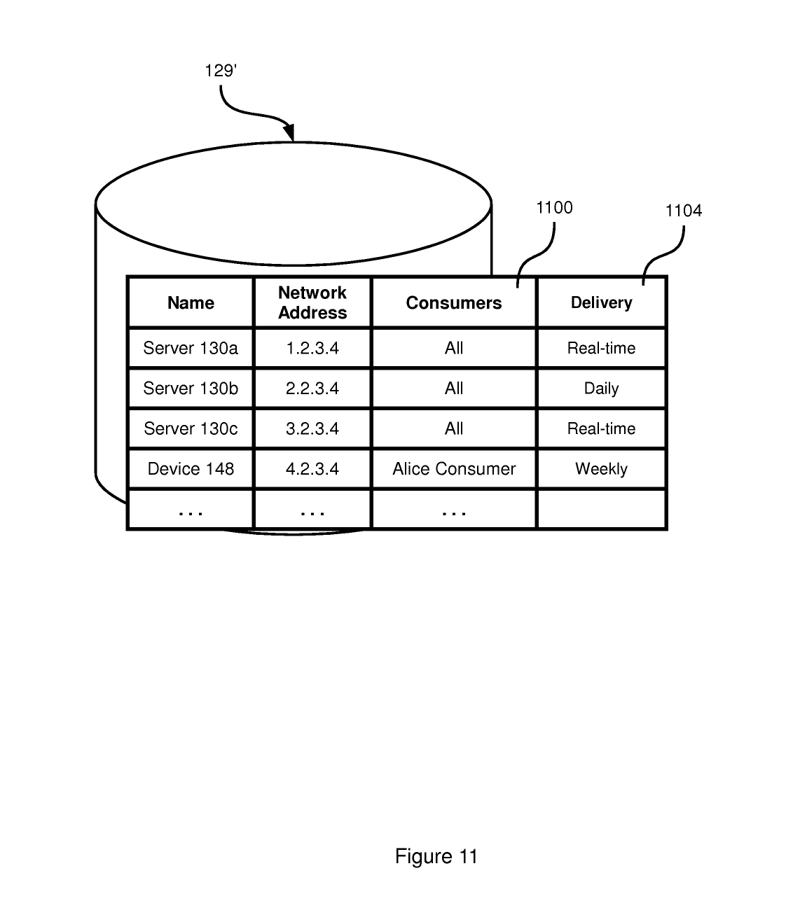

Variations to the above systems and methods are contemplated. For example, turning to FIG. 11, database 129 can include additional parameters for use in selecting subscriber identifiers and delivering second message 700. In particular, FIG. 11 shows an updated database 129′, in which the names and identifiers (in the form of network addresses) from FIG. 4 are shown. In addition, each record of database 129′ includes a consumer identifier field 1100 and a delivery scheduling field 1104. Computing device 104 can be configured, at block 325, to only select subscriber identifiers from database 129′ that are associated with consumer identifiers 1100 matching requester identifier 504. Thus, servers 130a, 130b and 130c are always selected according to database 129′, but device 148 is only selected when the credit request data received at block 810 identifies Alice Consumer. Thus, consumer device 148 is not informed of every hard credit inquiry made by computing device 104, but only of those hard credit inquiries made on behalf of Alice Consumer (who may be, for example, the operator of device 148).

Delivery scheduling field 1104 can be used by computing device 104 to determine when to send the second message at block 330. For example, the second message can be sent immediately after selecting subscriber identifiers, as indicated by the “real-time” values for servers 130a and 130c in FIG. 11. For other subscriber identifiers, the second message can be held until a daily timer expires. For example, computing device 104 can be configured to hold any second messages addressed to server 130b until the end of each business day. Those messages can then be combined into a single second message, including a requester identifier and corresponding information only indicator for each set of credit request data received at block 810 since the previous day. Other second messages, such as those addressed to consumer device 148, can be delivered only once per week (again, either individually or as a combined message). More generally, any suitable predetermined time period can be provided to delay the delivery of second messages.

In embodiments where second messages are held until the end of a day or week, the second messages can also be combined with other, unrelated messages. For example, computing device 104 can be configured to combine second message 700 with an alert relating to a financial account maintained by computing device 104 on behalf of consumer 58, when second message 700 is sent to consumer device 148 (that is, when consumer device 148 is a subscriber device). It is also contemplated that second message 700, when addressed to consumer device 148, can be modified to omit indicator 716, as consumer device 148 may not be capable of responding with credit report data and therefore may not need to be instructed not to do so.

In another example variation, second message 700 can include additional data, such as either or both of a portion or all of the credit request data, and a portion or all of the credit report data received in response to first message 600. The updates to databases 144 resulting from second message 700 can then include updates to other fields in addition to field 912.

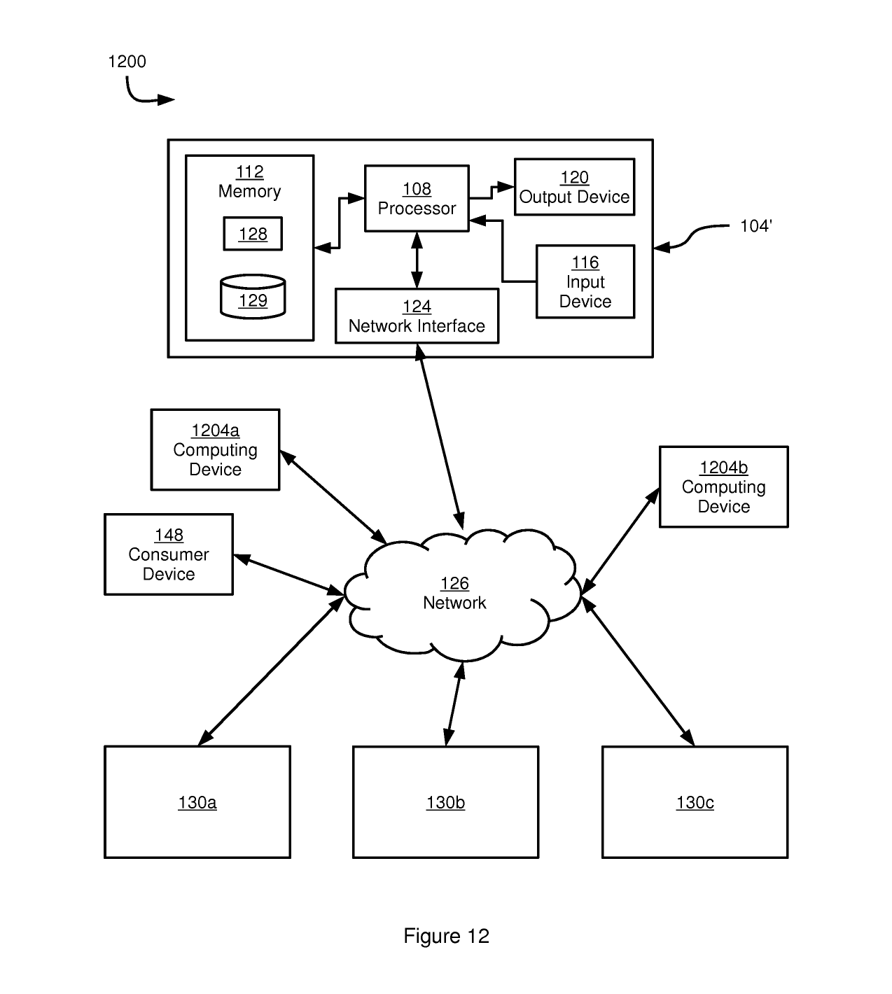

Referring now to FIG. 12, a variation of system 100 is shown, identified as system 1200. System 1200 includes a modified computing device 104′, servers 130 and consumer device 148. System 1200 also includes additional computing devices 1204a and 1204b. In system 1200, Devices 1204 can each be operated by lenders, such as lenders 54a and 54b. Computing device 104′, rather than being operated by a lender itself, can be operated by an aggregator that intermediates between lenders and CRAs. Thus, instead of receiving credit request data and generating message 600, computing device 104′ is configured to receive message 600 from devices 1204a and 1204b, and to forward message 600 to the relevant one of servers 130. Computing device 104′ is then configured to generate and send second message 700 as described above. In other words, the credit request data received by computing device 104′ at block 305 is represented by first message 600, which was sent by device 1204a or 1204b, and the first message sent by computing device 104′ at block 315 is represented by the forwarded copy of first message 600.

In an additional variation, each server 130 can be configured, following an affirmative determination at block 815, to create a record corresponding to the requester identified in the message received at block 810 if such a record did not already exist in database 144.

The computer readable instructions of applications 128 and 142 described herein can be configured and deployed in a variety of ways. For example, applications can include various modules each performing a subset of the functions described herein. As will be appreciated by those skilled in the art, applications 128 and 142 can be sub-routines, modules of other applications, or stand-alone applications, based on the computing environments in which applications 128 and 142 are deployed. Computing device 104 and each of servers 130 can be implemented as one or more physical computing devices, located at one or more sites (and connected by local or wide area networks). Applications 128 and 142 can be deployed on any number of such computing devices.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

1. A computing device comprising:
a memory storing a plurality of subscriber identifiers each corresponding to a subscriber device;
a network interface; and
a processor interconnected with the memory and the network interface, the processor configured to:
in response to receiving credit request data, transmit via the network interface a first message including a portion of the credit request data to a first server maintaining a credit database;
determine whether a response to the first message received from the first server includes credit report data corresponding to the credit request data, the credit report data for use in a decision whether to approve or deny a credit request;
when the determination is affirmative, select one or more of the subscriber identifiers, excluding any of the subscriber identifiers corresponding to the first server; and
independently of the decision, send a second message via the network interface to the subscriber devices corresponding to the selected subscriber identifiers, the second message including data based on the credit request data indicating that the first message was sent.

2. The computing device of claim 1 wherein the second message further includes an indicator for causing the subscriber devices not to respond to the second message with credit report data.

3. The computing device of claim 1 wherein the credit request data includes a requester identifier, and wherein the first and second messages each include the requester identifier.

4. The computing device of claim 3 wherein the one or more subscriber identifiers include an identifier corresponding to a consumer device associated with the requester identifier.

5. The computing device of claim 1 wherein the second message includes an identifier of an originator of the first message.

6. The computing device of claim 2 wherein at least one of the selected subscriber identifiers corresponds to an additional server maintaining an additional credit database, and wherein the second message further includes an instruction to update the additional credit database.

7. The computing device of claim 6 wherein each of the indicator and the instruction comprises a flag having one of two values.

8. (canceled)

9. The computing device of claim 1, the processor configured to repeat the receipt of credit request data, the transmitting, the determining, and the selecting, prior to sending the second message, wherein the second message includes data based on a portion of each credit request data received, and a separate indicator for each credit request data received.

10. The computing device of claim 1, the processor configured to send the second message after a predetermined time period has elapsed.

11. The computing device of claim 1, the processor configured to receive the credit request data by receiving the first message from an additional computing device, and to transmit the first message by forwarding the received first message to the first server.

12. A method in a computing device having a processor interconnected with a memory and a network interface, comprising:
storing, in the memory, a plurality of subscriber identifiers each corresponding to a subscriber device;
in response to receiving credit request data at the processor via the network interface, transmitting a first message including a portion of the credit request data from the network interface to a first server maintaining a credit database;
determining, at the processor, whether a response to the first message received from the first server includes credit report data corresponding to the credit request data, the credit report data for use in a decision whether to approve or deny a credit request;
when the determination is affirmative, selecting one or more of the subscriber identifiers at the processor, excluding any of the subscriber identifiers corresponding to the first server; and
independently of the decision, sending a second message from the network interface to the subscriber devices corresponding to the selected subscriber identifiers, the second message including data based on the credit request data indicating that the first message was sent.

13. The method of claim 12 wherein the second message further includes an indicator for causing the subscriber devices not to respond to the second message with credit report data.

14. The method of claim 12 wherein the credit request data includes a requester identifier, and wherein the first and second messages each include the requester identifier.

15. The method of claim 14 wherein the one or more subscriber identifiers include an identifier corresponding to a consumer device associated with the requester identifier.

16. The method of claim 12 wherein the second message includes an identifier of an originator of the first message.

17. The method of claim 12 wherein at least one of the selected subscriber identifiers corresponds to an additional server maintaining an additional credit database, and wherein the second message further includes an instruction to update the additional credit database.

18. The method of claim 17 wherein each of the indicator and the instruction comprises a flag having one of two values.

19. (canceled)

20. The method of claim 12, comprising repeating the receipt of credit request data, the transmitting, the determining, and the selecting, prior to sending the second message, wherein the second message includes data based on a portion of each credit request data received, and a separate indicator for each credit request data received.

21. The method of claim 12 wherein sending the second message comprises sending the second message after a predetermined time period has elapsed.

22. The method of claim 12 wherein receiving the credit request data comprises receiving the first message from an additional computing device, and wherein transmitting the first message comprises forwarding the received first message to the first server.

23-30. (canceled)
